(19) United States
(12) Patent Application Publication
(10) Pub. No.: US 2026/0175909 A1
(43) Pub. Date: Jun. 25, 2026

(54) STEERING SYSTEM

(71) Applicant: TOYOTA JIDOSHA KABUSHIKI KAISHA, Aichi-ken (JP)

(72) Inventors: Kazuki ITAZURI, Toyota-shi (JP); Shoji KUBOTA, Nagoya-shi (JP); Nobuyori NAKAJIMA, Kariya-shi (JP)

(21) Appl. No.: 19/411,363

(22) Filed: Dec. 8, 2025

(30) Foreign Application Priority Data
Dec. 24, 2024 (JP) 2024-227066

(51) Int. Cl. B62D 6/00; B62D 5/00; B62D 5/04

(52) U.S. Cl. CPC B62D 6/002; B62D 5/006; B62D 5/0409; B62D 5/0421; B62D 5/049

(57) ABSTRACT

A steering system includes an operation amount sensor configured to detect an operation amount of a steering operation member, an operation amount estimator configured to estimate an operation amount of the steering operation member which is not based on a detected value of the operation amount sensor, a steering mechanism including at least one steering actuator and a steering controller configured to control a steering angle of the pair of wheels. The steering controller is configured to control the at least one steering actuator based on an estimated operation amount when an operation amount estimation system including the operation amount estimator is normal and control the at least one steering actuator based on a sensor operation amount when the operation amount estimation system is abnormal. The estimated operation amount is estimated by the operation amount estimator. The sensor operation amount is detected by the operation amount sensor.

### REFERENCE TO RELATED APPLICATIONS

This application claims priority from Japanese Patent Application No. 2024-227066 filed on Dec. 24, 2024. The entire content of the priority application is incorporated herein by reference.

### TECHNICAL FIELD

This disclosure relates to a so-called steer-by-wire steering system.

### BACKGROUND ART

Japanese Patent Application Laid-Open No. 2003-063373 discloses an automatic evacuation apparatus having a steer-by-wire steering system. In the automatic evacuation apparatus described in Japanese Patent Application Laid-Open No. 2003-063373, when steering is disabled due to an abnormality of the steering system, the vehicle is driven to a safe place by changing a course by controlling right and left braking forces of steering wheels.

### SUMMARY

An object of the disclosure is to steer a pair of wheels satisfactorily in a steering system configured to steer the pair of wheels by controlling at least one steering actuator based on an operation amount of a steering operation member estimated by an operation amount estimator, even if an operation amount estimation system including the operation amount estimator is abnormal.

An aspect of the present disclosure relates to a steering system provided in a vehicle and configured to steer a pair of wheel mechanically disconnected from a steering operation member operable by a driver. The steering system includes an operation amount sensor configured to detect an operation amount of the steering operation member by the driver, an operation amount estimator configured to estimate an operation amount of the steering operation member which is not based on a detected value of the operation amount sensor, a steering mechanism including at least one steering actuator and configured to steer the pair of wheels by an operation of the steering actuator, and a steering controller configured to control a steering angle of the pair of wheels by controlling the at least one steering actuator based on the operation amount of the steering operation member. The steering controller is configured to control the at least one steering actuator based on an estimated operation amount when an operation amount estimation system including the operation amount estimator is normal and control the at least one steering actuator based on a sensor operation amount when the operation amount estimation system is abnormal. The estimated operation amount is the operation amount of the steering operation member estimated by the operation amount estimator. The sensor operation amount is the operation amount of the steering operation member detected by the operation amount sensor. As a result, even if the operation amount estimation system is abnormal, the pair of wheels can be well steered.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which;

FIG. 1 is a diagram conceptually showing an essential part of a steering system according to an embodiment of the present disclosure;

FIG. 2 is a perspective view conceptually showing the entire steering system;

FIG. 3A is a flowchart showing a reaction force control program stored in an operation side controller of the steering system;

FIG. 3B is a flowchart showing an operation amount estimation program stored in the operation side controller of the steering system;

FIG. 4 is a flowchart showing a steering control program stored in a steering controller of the steering system;

FIG. 5 is a flowchart showing an abnormal-situation control program stored in the steering controller of the steering system;

FIG. 6 is a flowchart showing another abnormal-situation control program different from the abnormal-situation control program illustrated in FIG. 5;

FIG. 7 is a flowchart showing another abnormal-situation control program different from the abnormal-situation control programs illustrated in FIG. 5 or 6;

FIG. 8 is a flowchart showing a switching control program stored in the steering controller;

FIG. 9 is a flowchart showing another switching control program different from the switching control program illustrated in FIG. 8;

FIG. 10 is a diagram showing a change in a steering torque of a steering motor when the switching control program shown in the flowchart of FIG. 8 is executed; and

FIG. 11 is a diagram showing a change in the steering torque of the steering motor when the switching control program shown in the flowchart of FIG. 9 is executed.

### DESCRIPTION

Hereinafter, a steering system according to an embodiment of the present disclosure will be described in detail with reference to the drawings.

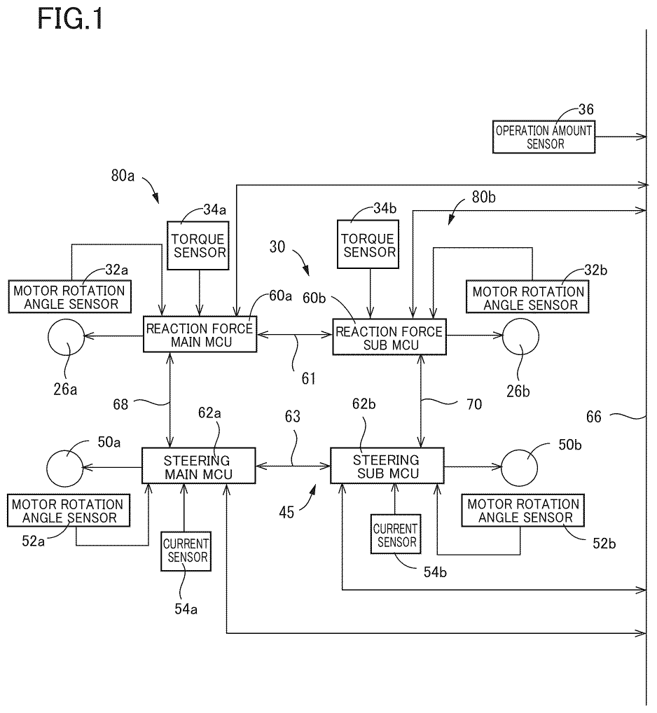

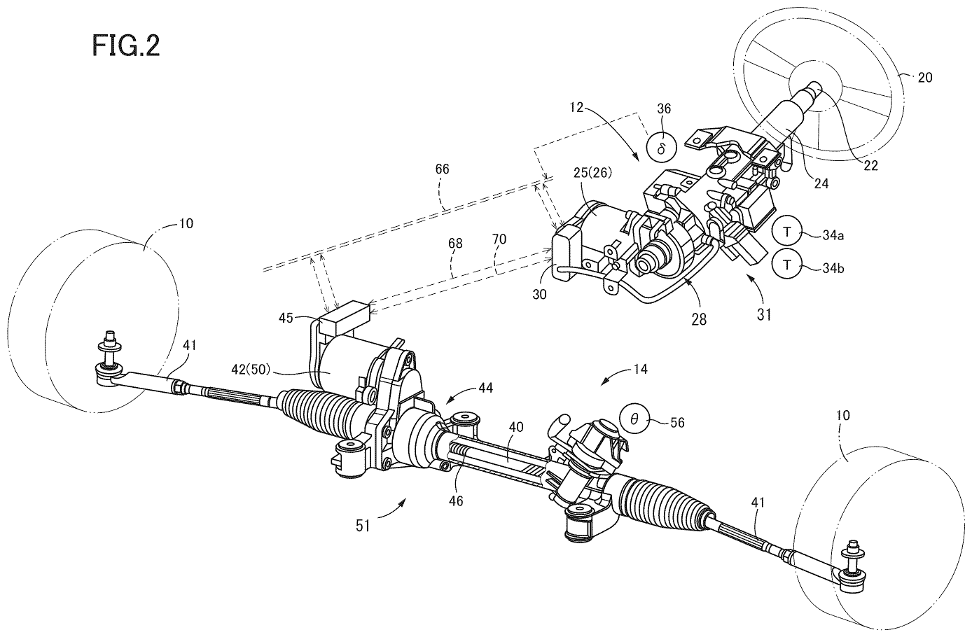

As shown in FIGS. 1 and 2, the steering system steers a pair of steering wheels 10. The pair of wheels 10 includes the left wheel 10 and the right wheel 10 (Hereinafter, these may be collectively referred to as the wheels 10 or each referred to as the wheel 10). The steering system includes an operating device 12, a steering device 14, and the like. The operating device 12 and the steering device 14 are mechanically disconnected from each other. The steering system is a so-called steer-by-wire type. Further, in the present embodiment, the steering system is designated to be redundant, and control and the like of the steering system are performed by 2 systems.

The operating device 12 includes a steering operation member 20, a steering shaft 22, a steering column 24, a reaction force actuator 25, a reaction force transmission mechanism 28, an operation side controller 30, and the like. The steering operation member 20 can be operated by a driver. In the present embodiment, the steering operation member 20 is of a rotary operation type and can be, for example, a steering wheel. The steering operation member 20 can be of a linear movement type. The steering operation member 20 is attached to one end of the steering shaft 22 so as to be integrally rotatable about an axis of the steering shaft 22. The reaction force actuator 25 is provided at the other end of the steering shaft 22 via the reaction force transmission mechanism 28.

The steering column 24 rotatably holds the steering shaft 22 and is supported by a vehicle body. The reaction force actuator 25 can be a device including a reaction force motor 26, or a device including the reaction force motor 26 and a reduction gear. The reaction force transmission mechanism 28 includes a plurality of gears and the like. A reaction force torque as a torque generated in the reaction force actuator 25 is applied to the steering operation member 20 through the reaction force transmission mechanism 28 and the steering shaft 22. An operation reaction force as the reaction force torque is applied to the steering operation member 20.

It is noted that, in the present embodiment, in the operating device 12, a reaction force applying mechanism 31 is composed of the steering shaft 22, the steering column 24, the reaction force transmission mechanism 28, the reaction force actuator 25 and the like.

The reaction force motor 26 is a 3-phase brushless DC motor and includes a rotary shaft as a rotor and a coil as a stator. The rotary shaft includes a magnet, and the coil includes two sets of mutually separable coils. In the reaction force motor 26, two sets of coils are provided for one rotary shaft. In the reaction force motor 26, each of the two sets of coils can be referred to as a reaction force motor 26a and a reaction force motor 26b, respectively. The reaction force motors 26a and 26b are provided with motor rotation angle sensors 32a and 32b for detecting rotation angles Θm of the reaction force motors 26a and 26b, respectively. Hereinafter, the reaction force motors 26a, 26b and the like may be simply referred to as the reaction force motor 26 and the like when there is no need to distinguish them or when they are collectively referred to as the reaction force motors.

The operating device 12 includes a torque sensor 34, an operation amount sensor 36, and the like. The operation amount sensor 36 detects an operation amount of the steering operation member 20. When the steering operation member 20 is a rotary operation type, the operation amount can be expressed by a rotation angle of the steering operation member 20 around an axis. More specifically, when a position of the steering operation member 20 in a straight-ahead state of the vehicle is a neutral position, the operation amount can be expressed by the rotation angle of the steering operation member 20 in each of left and right directions from the neutral position.

The torque sensor 34 detects an operation torque applied to the steering operation member 20 by a driver. A torsion bar is incorporated in the steering shaft 22, and the torque sensor 34 detects the operation torque is detected based on a twist amount of the torsion bar. In the present embodiment, 2 torque sensors 34 (torque sensors 34a, 34b) are provided.

The operation side controller 30 includes, as a main part, a computer, and controls the reaction force motor 26 to control the operation reaction force applied to the steering operation member 20, and estimates the operation amount of the steering operation member 20 based on an operation state of the reaction force motor 26. The operation amount of the steering operation member 20 is used in a steering control as described later. The operation side controller 30 controls the operation reaction force (hereinafter, it may be simply referred to as a reaction force), and can be referred to as a reaction force controller.

The operation side controller 30 includes reaction force MCUs (Micro Controller Unit or Motor Controller Unit) 60a and 60b provided corresponding to the reaction force motors 26a and 26b, respectively. The reaction force MCUs 60a and 60b include execution units, storage units, input/output units, and the like, respectively. The reaction force motors 26a and 26b are connected to the input/output units of the reaction force MCUs 60a and 60b via drive circuits, not shown, respectively, and the motor rotation angle sensors 32a and 32b, the torque sensors 34a and 34b, and the like are connected to the input/output units, respectively. Moreover, the reaction force MCUs 60a and 60b are communicatively connected to each other via a communication line 61.

The steering device 14 is configured to steer the pair of wheels 10 by one steering actuator 42, which is at least one steering actuator. The steering device 14 includes a steering rod 40, a tie rod 41, the steering actuator 42, a steering force transmission mechanism 44, a steering controller 45, and the like. As shown in FIG. 2, the steering rod 40 is held movably in a left and right direction by a housing provided on the vehicle body, and is connected to the wheels 10 through the tie rods 41. The steering actuator 42 can be a device including a steering motor 50, or can be a device including the steering motor 50 and a reduction gear (not shown).

The steering force transmission mechanism 44 functions as a motion conversion mechanism, and converts a rotation of the steering actuator 42 into a linear movement in the left and right direction, and transmits the movement to the steering rod 40. In the present embodiment, the steering force transmission mechanism 44 is a screw mechanism, and includes, for example, a screw portion 46, a nut member, a pulley, a belt, (not shown) and the like. The screw portion 46 is provided on the steering rod 40. The nut member is engaged with the screw portion 46. The rotation of the steering actuator 42 is transmitted to the nut member by a transmission member such as the pulley, the belt, and the like.

In the present embodiment, in the steering device 14, a steering mechanism 51 is composed of the steering rod 40, the tie rod 41, the steering actuator 42, the steering force transmission mechanism 44, and the like.

Similar to the reaction force motor 26, the steering motor 50 is a 3-phase brushless DC motor and includes two sets of coils separable from each other. These two sets of coils are referred to as a steering motor 50a and a steering motor 50b, respectively. The steering motors 50a and 50b are respectively provided with motor rotation angle sensors 52a and 52b for detecting rotation angles of electric motors. Further, current sensors 54a and 54b for detecting currents flowing through the steering motors 50a and 50b are respectively provided in drive circuits (inverters). The drive circuits are provided corresponding to the steering motors 50a and 50b, respectively. Hereinafter, the steering motors 50a, 50b and the like may be simply referred to as the steering motors 50 and the like when there is no need to distinguish them or when they are collectively referred to as the steering motors.

Further, the steering device 14 includes a steering angle sensor 56. The steering angle sensor 56 detects an amount of movement of the steering rod 40 in each of the left and right directions from the neutral position (the position at which the vehicle is in the straight-ahead state), thereby detecting a steering angle θ as an amount of steering of the wheels 10.

The steering controller 45 includes, as a main part, a computer and controls the steering angle of the wheel by controlling the steering motor 50. The steering controller 45 includes steering MCUs 62a, 62b and the like. The steering MCUs 62a, 62b are provided corresponding to the steering motors 50a, 50b, respectively. Each of the steering MCUs 62a, 62b includes an execution unit, a storage unit, an input/output unit and the like. The steering motors 50a, 50b are connected to the input/output units of the steering MCUs 62a, 62b via drive circuits not shown, and the motor rotation angle sensors 52a, 52b, the current sensors 54a, 54b and the like are connected to the input/output units, respectively. Moreover, the steering MCU 62a and the steering MCU 62b are communicably connected to each other via a communication line 63.

Further, the reaction force MCU 60a and the steering MCU 62a are communicably connected to each other via an L-CAN (Local Car Area Network or Local Controller Area Network) 68 which is a dedicated communication line. The reaction force MCU 60b and the steering MCU 62b are communicably connected to each other via an L-CAN 70 which is a dedicated communication line. Moreover, the reaction force MCUs 60a and 60b and the steering MCUs 62a and 62b are respectively connected to the operation amount sensor 36 or the like via a G-CAN (Global Controller Area Network) 66.

In the present embodiment, the reaction force motor 26a corresponds to a first reaction force motor, and the reaction force motor 26b corresponds to a second reaction force motor. The reaction force MCU 60a corresponds to a first reaction force controller, and the reaction force MCU 60b corresponds to a second reaction force controller. Moreover, the steering motor 50a corresponds to a first steering motor, and the steering motor 50b corresponds to a second steering motor. The steering MCU 62a corresponds to a first steering controller, and the steering MCU 62b corresponds to a second steering controller.

Further, the first reaction force controller may be referred to as the reaction force main MCU 60a, and the second reaction force controller may be referred to as the reaction force sub MCU 60b. The first steering controller may be referred to as the steering main MCU 62a, and the second steering controller may be referred to as the steering sub MCU 62b. The terms main and sub are used only for convenience, and the first reaction force controller can be referred to as the reaction force sub MCU, the first steering controller as the steering sub MCU, the second reaction force controller as the reaction force main MCU, and the second steering controller as the steering main MCU.

The operation of the steering system configured as described above will be described.

In the operation side controller 30, the reaction force MCUs 60a and 60b respectively control the reaction force motors 26a and 26b so that a target operation reaction force F* is applied to the steering operation member 20, and estimate the operation amount of the steering operation member 20 based on motor rotation angles Θma and Θmb of the reaction force motors 26a and 26b.

A target operation reaction force F* is obtained based on a steering load dependent component Ft and an assist force dependent component Fs according to the following equation. The target operation reaction force F* is set to a size at which the driver can feel that he/she is in a vehicle equipped with a steering system having a power steering mechanism and is performing manual steering. F*=Ft−Fs

The steering load dependent component Ft can be set to a size at which the driver can recognize a steering state (road surface state) of the wheels 10. When the wheel 10 is steered, the steering motor 50 outputs a larger torque when the load applied to the wheel 10 is larger than when the load is smaller. Therefore, the steering load dependent component Ft can be set to a size determined based on the steering torque which is a torque output by the steering motor 50. Moreover, the steering torque output by the steering motor 50 is obtained based on a current I supplied to the steering motor 50. Therefore, the steering load dependent component Ft can be set to a size corresponding to the supplied current I.

The assist force dependent component Fs can be regarded as a component for imparting an operation feeling to the driver in a so-called power steering system. In a power steering system, an assist torque corresponding to the operation torque is generally applied. Therefore, the assist force dependent component Fs can be set to a size determined based on the operation torque detected by the torque sensors 34a and 34b.

As described above, since the target operation reaction force F* is determined to be a size obtained by subtracting the assist force dependent component Fs from the steering load dependent component Ft, the driver can obtain a steering feeling as if the driver is performing manual operation while recognizing a state of the road surface.

Moreover, the operation amount of the steering operation member 20 is estimated based on rotation angles Θa and Θb of the reaction force motors 26a and 26b. In the operating device 12, the reaction force motor 26 is connected to the steering shaft 22 via the reaction force transmission mechanism 28. Therefore, a predetermined one-to-one relationship is established between a rotation angle Θ of the reaction force motor 26 and the operation amount of the steering operation member 20. Based on this relationship and the rotation angles Θa and Θb of the reaction force motors 26a and 26b detected by the motor rotation angle sensors 32a and 32b, operation amounts δa and δb of the steering operation member 20 can be estimated. Further, in the present embodiment, the neutral positions of the reaction force motors 26a and 26b are set before the vehicle is shipped. By accumulating the detected values of the motor rotation angle sensors 32a and 32b for each of the reaction force motors 26a and 26b, the rotation angles Θa and Θb from the neutral positions of the reaction force motors 26a and 26b are obtained, and the operation amounts δa and δb of the steering operation member 20 are estimated.

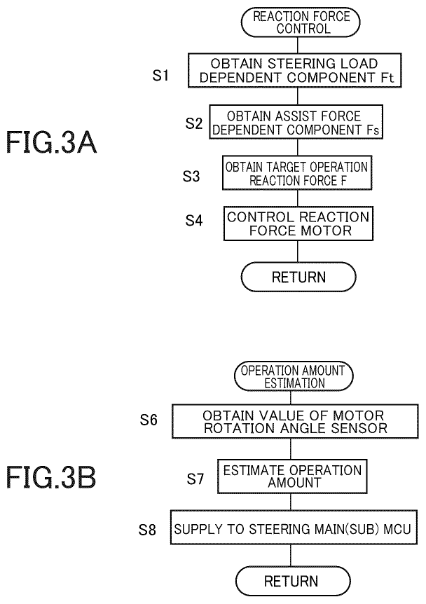

A reaction force control program shown in the flowchart of FIG. 3A and an operation amount estimation program shown in the flowchart of FIG. 3B are independently executed in each of the reaction force main MCU 60a and the reaction force sub MCU 60b. A case where the reaction force control program and the operation amount estimation program are executed in the reaction force main MCU 60a will be described below.

The reaction force control program is executed at predetermined set time intervals. A current Ia flowing through the steering motor 50a is supplied from the steering main MCU 62a to the reaction force main MCU 60a via the dedicated communication line (L-CAN) 68. A current Ib flowing through the steering motor 50b is supplied from the steering sub MCU 62b to the reaction force sub MCU 60b via a dedicated communication line 70.

In step 1 (hereinafter, step 1 is abbreviated as S1. the same shall apply to other steps), the current Ia flowing through the steering motor 50a supplied from the steering main MCU 62a is obtained, and the steering load dependent component Ft is obtained. In S2, the assist force dependent component Fs is obtained based on the operation torque detected by the torque sensor 34a. In S3, the target operation reaction force F* is obtained, and in S4, the current Ia supplied to the reaction force motor 26a is controlled so as to obtain the target operation reaction force F*.

The operation amount estimation program is also executed at predetermined set time intervals. In S6, the detected value of the motor rotation angle sensor 32a is obtained, and in S7, the rotation angle Θa of the reaction force motor 26a from the neutral position is obtained, and the operation amount δa of the steering operation member 20 is estimated. In S8, the main estimated operation amount δa as a first estimated operation amount, which is an operation amount of the steering operation member 20 estimated in the reaction force main MCU 60a, is supplied to the steering main MCU 62a via the dedicated communication line 68. It is noted that the same applies to the reaction force sub MCU 60b, and the sub estimated operation amount δb as a second estimated operation amount, which is an operation amount of the steering operation member 20 estimated in the reaction force sub MCU 60b, is supplied to the steering sub MCU 62b via the dedicated communication line 70.

In the steering controller 45, the steering main MCU 62a and the steering sub MCU 62b respectively control the steering motors 50a and 50b so that the wheels 10 steer at target steering angles θ*a and θ*b determined based on the operation amounts δa and δb of the steering operation member 20.

The target steering angles θ*a and θ*b can be obtained by multiplying the operation amounts δa and δb of the steering operation member 20 by a gain. For example, the gain can be a value corresponding to a steering gear ratio determined by the vehicle speed.

Target motor rotation angles θm*a and θm*b, which are rotation angles of the steering motors 50a and 50b, are obtained based on the target steering angles θ* a and θ* b. In the steering device 14, the rotation of the steering motor 50 is converted into the movement of the steering rod 40 via the steering force transmission mechanism 44, and the wheel 10 is steered. Therefore, a predetermined one-to-one relationship is established between the rotation angle of the steering motor 50 and the steering angle of the wheel 10. Further, motor rotation angle deviations Δθma and Δθmb, which are deviations between the target motor rotation angles θm* a and θm* b and actual motor rotation angles θmsa and θmsb, which are actual rotation angles of the steering motors 50a and 50b obtained based on the values detected by the motor rotation angle sensors 52a and 52b, are obtained.

Then, based on the motor rotation angle deviations Δθma and Δθmb, target steering torques T*a and T*b, which are torques required for the steering motors 50a and 50b, are obtained. Then, based on the target steering torques T*a and T*b, target currents I*a and I*b to be supplied to the steering motors 50a and 50b are determined. Then, a drive circuit (inverter) or the like is controlled so that currents Isa and Isb detected by the current sensors 54a and 54b approach the target currents I*a and I*b.

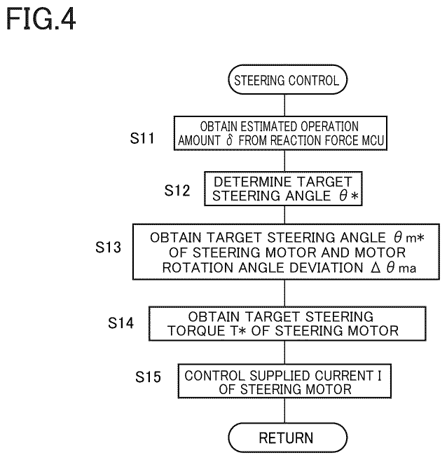

In each of the steering main MCU 62a and the steering sub MCU 62b, a steering control program represented by the flowchart of FIG. 4 is executed at predetermined set time intervals. The steering main MCU 62a and the steering sub MCU 62b independently obtain the target steering angles θ*a and θ*b based on the main estimated operation amount δa and the sub estimated operation amount δb, respectively, and control the steering motors 50a and 50b. In most cases, it is considered that the steering main MCU 62a and the steering sub MCU 62b perform similar control. A case where the steering control program shown in FIG. 4 is executed in the steering main MCU 62a will be described below.

In S11, the main estimated operation amount δa supplied from the reaction force main MCU 60a is obtained. In S12, the target steering angle θ*a is determined based on the main estimated operation amount δa. In S13, the target motor rotation angle θm*a of the steering motor 50a is obtained, and the actual motor rotation angle θmsa is obtained. Then, the motor rotation angle deviation Δθma is obtained. In S14, the target steering torque T*a for bringing the actual motor rotation angle θmsa closer to the target motor rotation angle θm*a is obtained, and the target current I*a for the steering motor 50a is obtained so as to obtain the target steering torque T*a. In S15, the drive circuit is controlled so that the current Isa detected by the current sensor 54a approaches the target current I*a.

However, due to an abnormality, there is a case where the main estimated operation amount δa is not supplied from the reaction force main MCU 60a the steering main MCU 62a. Similarly, due to an abnormality, there is a case where the sub estimated operation amount δb is not supplied from the reaction force sub MCU 60b to the steering sub MCU 62b. Also, there is a case where the supplied main estimated operation amount Sa and the sub estimated operation amount δb are abnormally large. In such cases, it becomes difficult to control the steering motors 50a and 50b by the steering main MCU 62a and the steering sub MCU 62b.

In the present embodiment, abnormalities include, for example, abnormalities in the motor rotation angle sensors 32a and 32b, defects in the reaction force main MCU 60a and the reaction force sub MCU 60b, communication abnormalities in the dedicated communication lines (L-CAN) 68 and 70, disconnections in the dedicated communication lines 68 and 70, and abnormalities in the reaction force motors 26a and 26b. Since these abnormalities are abnormalities in elements (including elements used for estimating the operation amount δ) related to the estimation of the operation amount δ of the steering operation member 20, they can be referred to as abnormalities in the operation amount estimation system. The operation amount estimation system includes an operation amount estimation main system 80a and an operation amount estimation sub system 80b. The operation amount estimation main system 80a and the operation amount estimation sub system 80b can be referred to as the reaction force main system 80a and the reaction force sub system 80b.

The presence or absence of an abnormality in the reaction force main system 80a and the presence or absence of an abnormality in the reaction force sub system 80b may be respectively obtained in the reaction force main MCU 60a and the reaction force sub MCU 60b and respectively supplied to the steering main MCU 62a and the steering sub MCU 62b, or respectively obtained in the steering main MCU 62a and the steering sub MCU 62b. For example, the abnormalities in the motor rotation angle sensors 32a and 32b may be respectively obtained by the reaction force main MCU 60a and the reaction force sub MCU 60b themselves. Moreover, the defects in the reaction force main MCU 60a and the reaction force sub MCU 60b, the communication abnormalities, the disconnection or the like in the dedicated communication lines 68 and 70 can be obtained in the steering main MCU 62a and the steering sub MCU 62b, respectively.

In either cases, the reaction force MCUs 60a and 60b and the steering MCUs 62a and 62b are communicatively connected to each other by the dedicated communication lines 68 and 70, the communication lines 61 and 63 or the like. Therefore, the presence or absence of the abnormalities in the reaction force main system 80a and the reaction force sub system 80b can be also obtained by either the reaction force MCUs 60a and 60b or the steering MCUs 62a and 62b. Moreover, an abnormal-situation control, which is a control when the reaction force main system 80a and the reaction force sub system 80b are abnormal, may be executed by the steering MCUs 62a and 62b, respectively.

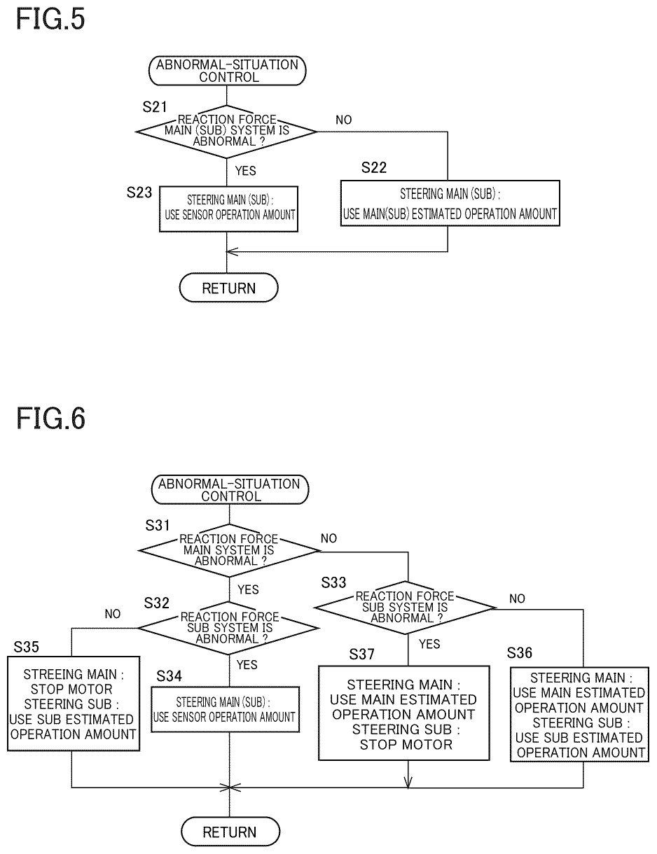

An example of an abnormal-situation control program representing the abnormal-situation control is shown in the flowchart of FIG. 5. In the present embodiment, when the reaction force main system 80a is not abnormal (normal), the steering main MCU 62a controls the steering motor 50a based on the main estimated operation amount δa. When the reaction force sub system 80b is normal, the steering sub MCU 62b controls the steering motor 50b based on the sub estimated operation amount δb. On the other hand, when the abnormality is detected in the reaction force main system 80a, the steering main MCU 62a obtains a sensor operation amount δs, which is an operation amount detected by the operation amount sensor 36, via the G-CAN 66, and controls the steering motor 50a based on the sensor operation amount δs. When the abnormality is detected in the reaction force sub system 80b, the steering sub MCU 62b controls the steering motor 50b based on the sensor operation amount δs obtained via the G-CAN 66.

The abnormal-situation control program shown in the flowchart of FIG. 5 is executed at predetermined set time intervals in each of the steering main MCU 62a and the steering sub MCU 62b. In the embodiment, an execution in the steering main MCU 62a will be described, and an execution in the steering sub MCU 62b will be omitted.

In S21, it is determined whether or not the reaction force main system 80a is abnormal. In S21, there is a case where information indicating the motor rotation angle sensor 32a is abnormal is supplied from the reaction force main MCU 60a. If the determination in S21 is NO, in S22, the steering main MCU 62a controls the steering motor 50a based on the main estimated operation amount δa. If the determination in S21 is YES, in S23, the steering main MCU 62a controls the steering motor 50a based on the sensor operation amount δs.

It is noted that the abnormal-situation control may be performed according to an abnormal-situation control program shown in the flowchart of FIG. 6. In the present embodiment, when one of the reaction force main system 80a and the reaction force sub system 80b is normal and the other is abnormal, the steering motor 50 corresponding to the abnormal system is stopped. When both the reaction force main system 80a and the reaction force sub system 80b are abnormal, the steering main MCU 62a and the steering sub MCU 62b control the steering motors 50a and 50b based on the sensor operation amount δs, respectively.

When traveling on public roads (surface roads), if the steering motor 50a is controlled by the steering main MCU 62a based on the main estimated operation amount δa, the target steering angle θ* can be realized in most cases even when the steering motor 50b is in a stopped state. In addition, it is more desirable from a viewpoint of traveling safety of the vehicle that a steering force is insufficient and the vehicle tends to understeer in an abnormal state. This is because it is undesirable that, in the abnormal state, the steering force becomes large against an intention of the driver and the wheels 10 are steered against the intention of the driver and the vehicle tends to oversteer. Therefore, in the present embodiment, when either one of the reaction force main system 80a and the reaction force sub system 80b is abnormal, the steering motor 50a or the steering motor 50b corresponding to either one is stopped.

The abnormal-situation control program shown in the flowchart of FIG. 6 is similarly executed in each of the steering main MCU 62a and the steering sub MCU 62b. Through communication via the communication line 63, the steering sub MCU 62b supplies information on whether the reaction force sub system 80b is abnormal to the steering main MCU 62a, and the steering main MCU 62a supplies information on whether the reaction force main system 80a is abnormal to the steering sub MCU 62b.

In S31, it is determined whether the reaction force main system 80a is abnormal, and when it is abnormal, in S32, it is determined whether the reaction force sub system 80b is abnormal. On the other hand, when the reaction force main system 80a is normal, in S33, it is determined whether the reaction force sub system 80b is abnormal.

When both the reaction force main system 80a and the reaction force sub system 80b are abnormal, the determination in S32 is YES, and S34 is executed. In S34, the steering main MCU 62a controls the steering motor 50a based on the sensor operation amount δs, and the steering sub MCU 62b also controls the steering motor 50b based on the sensor operation amount δs.

When the reaction force main system 80a is abnormal but the reaction force sub system 80b is normal, the steering main MCU 62a stops the steering motor 50a in S35. When the reaction force main system 80a is normal, in S36 and S37, the steering main MCU 62a controls the steering motor 50a based on the main estimated operation amount δa supplied from the reaction force main MCU 60a, regardless of whether the reaction force sub system 80b is normal or abnormal.

On the other hand, when the reaction force sub system 80b is abnormal and the reaction force main system 80a is normal, the steering sub MCU 62b stops the steering motor 50b (S37). When the reaction force sub system 80b is normal, in S35 and S36, the steering sub MCU 62b controls the steering motor 50b based on the sub estimated operation amount δb, regardless of whether the reaction force main system 80a is normal or abnormal.

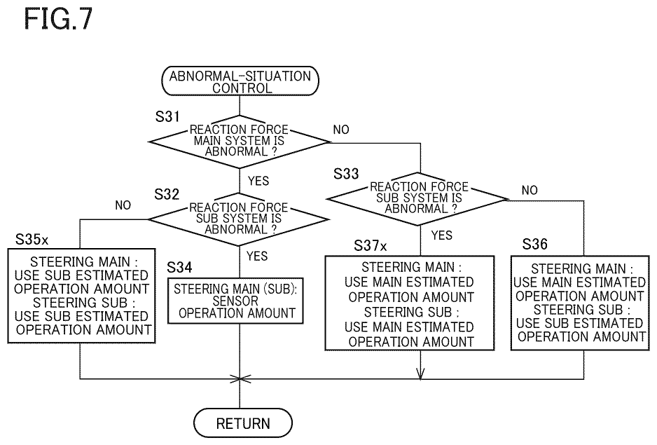

The abnormal-situation control can also be performed according to an abnormal-situation control program shown in the flowchart of FIG. 7. In the flowchart of FIG. 7, steps that are similarly executed in the abnormal-situation control program shown in the flowchart of FIG. 7 and the abnormal-situation control program shown in the flowchart of FIG. 6 are given similar step numbers, and description thereof is omitted. The sub estimated operation amount δb is supplied from the steering sub MCU 62b to the steering main MCU 62a via the communication line 63, and the main estimated operation amount δa is supplied from the steering main MCU 62a to the steering sub MCU 62b via the communication line 63.

When the reaction force main system 80a is abnormal and the reaction force sub system 80b is normal, both the steering main MCU 62a and the steering sub MCU 62b control the steering motors 50a and 50b based on the sub estimated operation amount δb in S35x. When the reaction force main system 80a is normal and the reaction force sub system 80b is abnormal, both the steering sub MCU 62b and the steering main MCU 62a control the steering motors 50a and 50b based on the main estimated operation amount δa in S37x.

As described above, when the reaction force main system 80a and the reaction force sub system 80b are abnormal, the steering motors 50a and 50b are controlled based on the sensor operation amount δs in each of the steering MCUs 62a and 62b. As a result, the wheel 10 can be steered more favorably than in a case of an automatic evacuation apparatus described in Japanese Patent Application Laid-Open No. 2003-063373. Further, when the abnormal-situation control program shown in each of the flowcharts of FIGS. 5 and 7 is executed, the insufficient steering torque at the abnormal situation can be compensated more favorably than when the abnormal-situation control program shown in the flowchart of FIG. 6 is executed, and the wheel 10 can be steered more favorably. For example, the wheel 10 can be steered favorably even when so-called stationary steering (steering on the spot) is performed (even if the steering operation member 20 is operated in the stopped state of the vehicle).

On the other hand, the main estimated operation amount δa, the sub estimated operation amount δb, and the sensor operation amount δs are not always the same. For example, the neutral positions at which the main estimated operation amount δa, the sub estimated operation amount δb and the sensor operation amount δs are respectively obtained may be different from one another, and they may have different values. Further, although the rotation angles Θma, Θmb of each of the reaction force motors 26a and 26b are obtained by accumulating the detected values of the motor rotation angle sensors 32a and 32b, there may be a case where a deviation occurs between the main estimated operation amount δa, the sub estimated operation amount δb and the sensor operation amount δs due to the accumulation of the detected values.

Therefore, for example, there is a possibility that the target steering angle θ* (θ*ae) of the wheel 10 determined based on the main estimated operation amount δa is different from the target steering angle θ* (θ*ae) determined based on the sensor operation amount δs, and the steering angle of the wheel 10 may change drastically. Accordingly, when the control of the steering motors 50a and 50b based on the main estimated operation amount δa is switched to the control of the steering motors 50a and 50b based on the sensor operation amount δs due to the abnormality in the reaction force main system 80a, the control of the steering motor 50a is gradually switched.

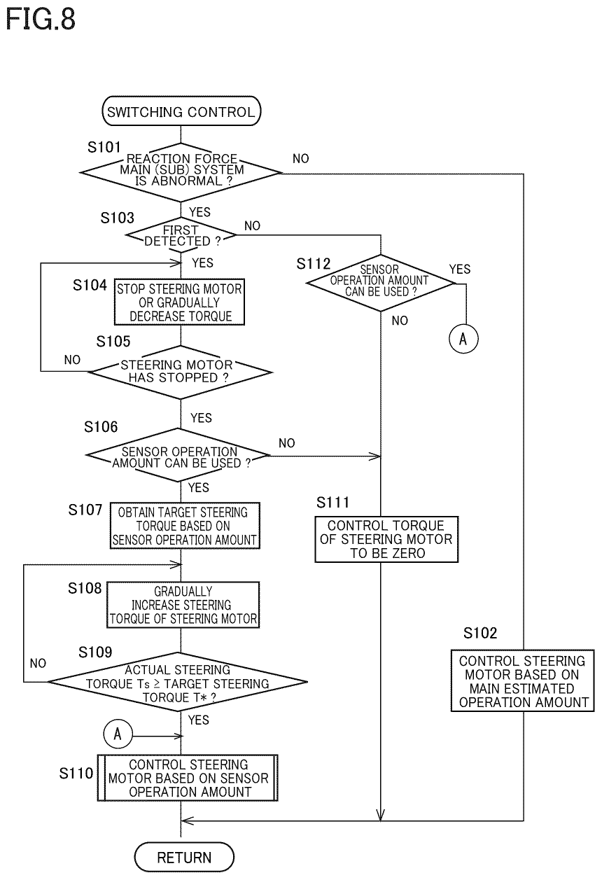

A switching control program as an example of such the case is shown by a flowchart of FIG. 8. In the present embodiment, a case where the switching control program is executed in the steering main MCU 62a will be described. Descriptions of the execution in the steering sub MCU 62b will be omitted. It is noted that this switching control program may be referred to as an abnormal-situation control program including the switching control.

In the present embodiment, when the abnormality of the reaction force main system 80a is detected, the steering motor 50a is temporarily stopped. This is because, as described above, the wheels 10 can be steered at the target steering angle θ* even if the steering motor 50a is stopped during normal running, and lowering of running stability of the vehicle can be suppressed if the steering motor is controlled toward an understeer tendency.

In S101, it is determined whether or not the reaction force main system 80a is abnormal. When the reaction force main system 80a is normal and the determination is NO, a normal control is performed in S102. That is, the steering motor 50a is controlled based on the main estimated operation amount δa.

When the reaction force main system 80a is abnormal and the determination in S101 is YES, it is determined in S103 whether or not the abnormality of the reaction force main system 80a is first detected. For example, in a previous execution of this program, the determination in step 101 was NO, and it is determined whether or not the determination is YES this time.

When the determination in S103 is YES, the steering motor 50a is stopped in S104. The steering motor 50a may be stopped immediately, or may be stopped by gradually decreasing the steering torque. In S105, it is determined whether or not the steering motor 50a has stopped. For example, when the current Ia to the steering motor 50a is 0, or when the steering torque is not output by the steering motor 50a, it can be determined that the steering motor 50a has stopped. S104 and S105 are repeatedly executed until the steering motor 50a has stopped.

When the determination in S105 is YES, it is determined in S106 whether or not the sensor operation amount δs can be used. For example, this can be a case where the sensor operation amount δs is not an inappropriate amount (for example, the sensor operation amount δs does not exceeds an upper and lower limits), or a case where an absolute value of a difference between the sensor operation amount δs and the main estimated operation amount δa obtained last time is equal to or less than a set value. When the operation amount sensor 36 is abnormal or when a communication abnormality occurs in the G-CAN66, it is determined that the sensor operation amount δs cannot be used, and the determination in step 106 can be NO.

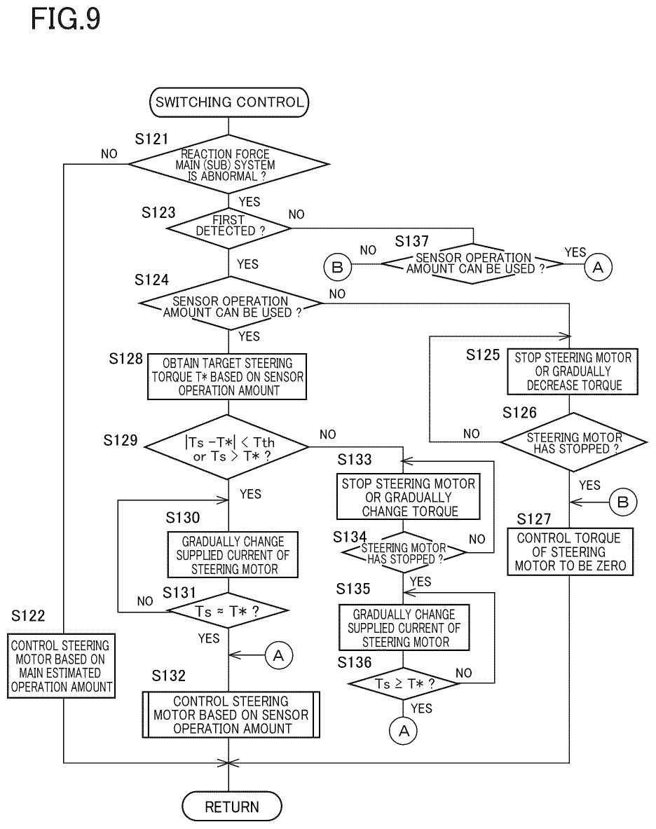

When the determination in S106 is YES, in S107, the target steering angle θ* (θ*ae) of the wheel 10 is obtained based on the sensor operation amount δs. Further, the target motor rotation angle θm*a of the steering motor 50a corresponding to the target steering angle θ* (θ*ae) of the wheel 10 is obtained, and the target steering torque T*a of the steering motor 50a is obtained. In S108, for example, the supplied current Ia to the steering motor 50a is gradually increased and the steering torque output by the steering motor 50a is gradually increased. In S109, an actual steering torque Tsa of the steering motor 50a is obtained based on an actual current Is, which is a current flowing through the steering motor 50a detected by the current sensor 54a. Then, it is determined whether the actual steering torque Tsa has reached the target steering torque T*a. Hereinafter, T*a and T*b may be simply referred to as T*, and Tsa and Tsb may be simply referred to as Ts. The same applies to FIGS. 8 and 9.

For example, in S108, a deviation ΔT between the target steering torque T* and the actual steering torque Ts obtained in S107 is divided by n, and the suppled current I can be gradually increased so as to approach the target steering torque T* by ΔT/n in one control. Also, the supplied current Ia to the steering motor 50a can be incremented by a predetermined increment Ala.

In any case, S108 and S109 are repeatedly executed until the determination in S109 becomes YES. When the determination in step 109 becomes YES, thereafter, the steering motor 50a is controlled based on the sensor operation amount δs in step 110.

On the other hand, when the determination in S106 is NO and it is determined that the sensor operation amount δs cannot be used to control the steering motor 50, the steering motor 50a is kept stopped in S111.

It is noted that, before S111 is executed, a step for determining whether or not the reaction sub system 80b is normal may be provided. When the reaction sub system 80b is normal and the determination in this step is YES, step 111 can be executed. It is appropriate to hold the steering motor 50a in the stopped state when the steering motor 50b is in an operating state. Similarly, before S104 is executed, a step for determining whether or not the reaction sub system 80b is normal may be provided. On the other hand, it is considered that both the reaction force main system 80a and the reaction force sub system 80b rarely become abnormal.

If the determination in S103 is NO and it is not the first time that the reaction force main system 80a is detected to be abnormal, it is determined in S112 whether the sensor operation amount δs can be used. When the determination is YES, S110 is executed, and when the determination is NO, S111 is executed. After the switching control is completed, the steering motor 50a is either controlled based on the sensor operation amount δs or held in the stopped state.

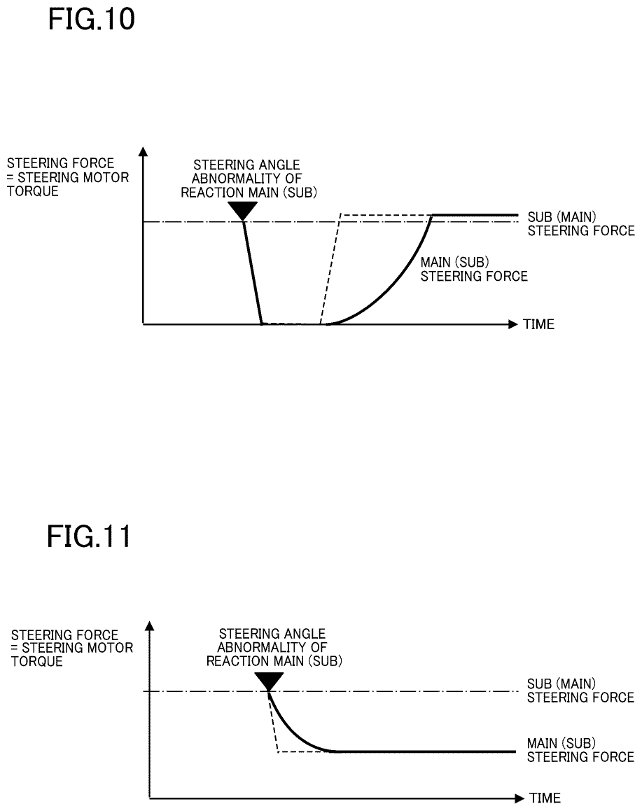

In FIG. 10, a change in the steering torque of the steering motor 50a when this program is executed is shown by a solid line, and a change in the steering torque of the steering motor 50a when the supplied current Ia is immediately increased after the steering motor 50a is stopped is shown by a broken line. Comparing these, by executing this switching control program, the steering torque output by the steering motor 50a can be gradually increased, and the change in the steering angle of the wheel 10 can be suppressed. As a result, lowering of running stability of the vehicle can be suppressed, and discomfort of the driver can be reduced. It should be noted that while the embodiments described in FIGS. 8 and 10, etc., illustrate a case where the steering torque increases from zero when switching from the control based on the main estimated operation amount δa to the control based on the sensor operation amount δs, the steering torque is not necessarily restricted to increasing.

When the reaction force main system 80a is abnormal, it is not essential to temporarily stop the steering motor 50a. In the present embodiment, the control of the steering motor 50a based on the main estimated operation amount δa is gradually switched to the control based on the sensor operation amount δs without temporarily stopping the steering motor 50a. An example of the switching control program (abnormal-situation control program including switching control) in this case is shown by a flowchart of FIG. 9. A case where this program is executed in the steering main MCU 62a will be described. Since it is also executed in the steering sub MCU 62b in the same manner, descriptions thereof will be omitted.

S121 to 123 are executed in the same manner as S101 to S103 described above. In S121, it is determined whether or not the reaction force main system 80a is abnormal. If it is normal, in S122, the steering motor 50a is controlled based on the main estimated operation amount δa. When the reaction force main system 80a is abnormal, in S123, it is determined whether or not the reaction force main system 80a is first determined to be abnormal.

If the determination in S123 is YES, it is determined in S124 whether or not the sensor operation amount δs can be used. When the determination is NO, in S125, S126 and S127, the steering motor 50a is stopped as in the execution of the aforementioned S104, S105 and S111, and then the steering motor 50a is held in the stopped state.

When the determination in S124 is YES, in S128, the target steering torque T* of the steering motor 50a is obtained based on the sensor operation amount s. In S129, it is determined whether or not an absolute value of a difference between the target steering torque T* based on the sensor operation amount δs and the actual steering torque Ts of the steering motor 50a is smaller than a threshold value Tth, or whether or not an absolute value of the target steering torque T* based on the sensor operation amount δs is smaller than an absolute value of the actual steering torque Ts.

If the absolute value of the difference between the target steering torque T* based on the sensor operation amount δs and the actual steering torque Ts of the steering motor 50a is larger than or equal to the threshold value Tth, the absolute value of the steering angle greatly changes when the control of the steering motor 50a based on the main estimated operation amount δa is switched to the control of the steering motor 50a based on the sensor operation amount δs, which is undesirable.

If the absolute value of the target steering torque T* based on the sensor operation amount δs is larger than the absolute value of the actual steering torque Ts of the steering motor 50a, the steering angle increases against the intention of the driver when the control of the steering motor 50a based on the main estimated operation amount δa is switched to the control of the steering motor 50a based on the sensor operation amount δs. The vehicle unintentionally tends to oversteer, which is undesirable from the viewpoint of running stability.

As described above, when the determination in S129 is NO, the control based on the main estimated operation amount δa is not directly switched to the control based on the sensor operation amount δs.

When the determination in S129 is YES, in S130 and S131, the supply current to the steering motor 50a is gradually changed, the actual steering torque Ts of the steering motor 50a is gradually changed, and it is determined whether or not the actual steering torque Ts approaches the target steering torque T* based on the sensor operation amount δs. S130 and S131 are repeatedly executed until the actual steering torque Ts of the steering motor 50a approaches the target steering torque T*. When the determination in S131 is YES, in S132 thereafter, the steering motor 50a is controlled based on the sensor operation amount δs.

It should be noted that, before S129 or before S130, a step of determining whether or not a changing speed of the sensor operation amount δs is smaller than a set speed or whether or not the vehicle is in a stopped state (whether or not a vehicle traveling speed is equal to or lower than a set speed) may be provided, and when the determination is YES, S130 may be executed. When the steering speed is high, it is undesirable to switch the control of the steering motor 50a from the viewpoint of suppressing deterioration of traveling stability. Further, if the control of the steering motor 50a is switched while the vehicle is stopped, safety can be improved.

On the other hand, if the determination in S129 is NO, in S133-S136, the steering motor 50a is stopped in the same manner as in the executions of S104, S105, S108 and S109 described above. Thereafter, the supplied current Ia to the steering motor 50a is gradually increased to bring the actual steering torque Ts closer to the target steering torque T* determined based on the sensor operation amount δs. When the determination in S136 is YES, in S132, thereafter, the steering motor 50a is controlled based on the sensor operation amount δs.

When the determination in S123 is NO, in S137, it is determined whether or not the sensor operation amount δs can be used. When the determination is YES, S132 is executed, and if the determination is NO, S127 is executed.

FIG. 11 shows an example of the change in the steering torque of the steering motor 50a when this program is executed. In the present embodiment, as indicated by a solid line, the steering torque of the steering motor 50a is gradually changed from the control based on the main estimated operation amount Sa to the control based on the sensor operation amount δs without stopping the steering motor 50a. As a result, as compared with a case indicated by a broken line, it is possible to suppress a rapid change in the steering angle of the wheel 10 and to suppress lowering of running stability of the vehicle. In addition, it is possible to reduce a sense of discomfort of the driver.

As described above, in the present embodiment, an operation amount estimator is composed of a portion that stores the operation amount estimation program of the operation side controller 30, a portion that executes the operation amount estimation program, and the like. Further, the reaction force main system 80a corresponds to a first reaction force control system, and the reaction force sub system 80b corresponds to a second reaction force control system.

It should be noted that a structure of the steering device 14 is not limited to the structure in the present embodiments. For example, the present disclosure can be applied to a steering device having a structure in which each of the pair of wheels 10 is provided with a steering actuator, and each of the wheels is steered by a corresponding one of the steering actuators.

In addition, the present disclosure can be implemented in various forms with various modifications and improvements based on the knowledge of a person skilled in the art.

Claimable inventions are as follows.

(1) A steering system provided in a vehicle and configured to steer a pair of wheel mechanically disconnected from a steering operation member operable by a driver, the steering system comprising:
an operation amount sensor configured to detect an operation amount of the steering operation member by the driver;
an operation amount estimator configured to estimate an operation amount of the steering operation member which is not based on a detected value of the operation amount sensor;
a steering mechanism including at least one steering actuator and configured to steer the pair of wheels by an operation of the steering actuator; and
a steering controller configured to control a steering angle of the pair of wheels by controlling the at least one steering actuator based on the operation amount of the steering operation member,
wherein the steering controller is configured to:
   control the at least one steering actuator based on an estimated operation amount when an operation amount estimation system including the operation amount estimator is normal and
   control the at least one steering actuator based on a sensor operation amount when the operation amount estimation system is abnormal,
   the estimated operation amount being an operation amount of the steering operation member estimated by the operation amount estimator, the sensor operation amount being an operation amount of the steering operation member detected by the operation amount sensor.

The steering mechanism may have a structure in which one steering actuator is provided corresponding to a pair of wheels, or a structure in which a steering actuator is provided corresponding to each of the pair of wheels.

At least one of the reaction force main system 80a and the reaction force sub system 80b corresponds to the operation amount estimation system. At least one of the main estimated operation amount and the sub estimated operation amount corresponds to the estimated operation amount.

(2) The steering system according to item (1) wherein the steering controller is configured to control the steering actuator based on the sensor operation amount when the operation amount estimation system is abnormal and the sensor operation amount detected by the operation amount sensor is an appropriate amount for controlling the steering actuator.

When the operation amount sensor is abnormal or communication between the operation amount sensor and the steering controller is abnormal, the detected value of the operation amount sensor is considered to be a value not appropriate for controlling the steering actuator.

When the detected value of the operation amount sensor is an inappropriate value, the steering actuator can be stopped or the steering actuator can be controlled based on the estimated operation amount estimated in the first reaction force controller and the second reaction force controller in the above embodiment.

(3) The steering system according to item (1) or item (2), further comprising:
a reaction force applying mechanism including a reaction force actuator coupled to a steering shaft via a reaction force transmission mechanism and configured to apply an operation reaction force to the steering operation member by an operation of the reaction force actuator, the steering operation member being coupled to the steering shaft; and
a reaction force controller configured to control the operation reaction force applied to the steering operation member by controlling the reaction force actuator,
wherein the operation amount estimator is configured to estimate the operation amount of the steering operation member based on a rotation angle of the reaction force actuator.

The steering operation member according to this item is rotatably operable. Since the steering operation member and the reaction force actuator are coupled via the steering shaft, the operation amount of the steering operation member and the rotation amount of the reaction force actuator have a one-to-one relationship. The operation amount estimator may be included in the reaction force controller.

The presence or absence of an abnormality of the operation amount estimation system may be detected by the steering controller or by another controller (for example, a general controller) different from the steering controller. Moreover, the presence or absence of an abnormality of the operation amount estimation system may be detected by the operation amount estimator.

(4) The steering system according to item (1) or item (2), wherein the steering controller is configured to estimate the operation amount of the steering operation member based on an operating torque applied to the steering operation member by the driver.

(5) The steering system according to any one of item (1) to item (4), wherein, when an abnormality of the operation amount estimation system is detected, the steering controller is configured to gradually change a control of the at least one steering actuator in a case where the control is switched from the control of the at least one steering actuator based on the estimated operation amount to the control of the at least one steering actuator based on the sensor operation amount.

For example, the changing of the control of the steering actuator includes changing of the supply current to the steering actuator, changing of the steering torque as an output of the steering actuator, changing of a rotation angle of the steering actuator, changing of the steering angle of the wheel, and the like.

(6) The steering system according to item (5), wherein, when the abnormality of the operation amount estimation system is detected, the steering controller is configured to stop the at least one steering actuator and then is configured to gradually increase a supplied current to the at least one steering actuator such that the steering angle of the pair of wheels approaches a target steering angle determined based on the sensor operation amount.

The motor rotation angle corresponding to the rotation angle of the steering actuator and the steering angle of the wheel correspond one-to-one. The target steering angle of the wheel is obtained based on the sensor operation amount, and the target motor rotation angle of the steering actuator is obtained based on the target steering angle. Moreover, the target steering torque which is a torque required for the steering actuator to bring an actual motor rotation angle which is an actual rotation angle of the steering actuator close to the target motor rotation angle is obtained based on a deviation between the target motor rotation angle and the actual motor rotation angle. Then, as the supplied current to the steering actuator increases, the steering torque generated in the steering actuator increases, and the rotation angle of the steering actuator increases, and the steering angle of the wheel increases.

As described above, the “steering angle of the pair of wheels” described in paragraph (6) can be replaced with the “rotation angle of the at least one steering actuator” or the “steering torque of the at least one steering actuator”. It is the same for item (7) and item (8).

In addition, the at least one steering actuator is often controlled in the same manner. It is desirable that the pair of wheels are steered at the same steering angle.

(7) The steering system according to item (5), wherein, when an absolute value of a difference between an actual steering angle of the pair of wheels and a target steering angle determined based on the sensor operation amount is smaller than a threshold value, the steering controller is configured to gradually change a supplied current to the at least one steering actuator such that the steering angle of the pair of wheels approaches the target steering angle, in a case where the abnormality of the operation amount estimation system is detected.

The actual steering angle of the pair of wheels can be replaced with the target steering angle determined based on the estimated operation amount immediately before the abnormality of the operation amount estimation system is detected. It is the same for item (8).

(8) The steering system according to item (5) or item (7), wherein, when an absolute value of the actual steering angle of the pair of wheels is greater than an absolute value of a target steering angle determined based on the sensor operation amount, the steering controller is configured to gradually change a supplied current to the at least one steering actuator such that the steering angle of the pair of wheels approaches the target steering angle, in a case where the abnormality of the operation amount estimation system is detected.

(9) The steering system according to any one of item (1) to item (8), further comprising:
a reaction force applying mechanism including a reaction force actuator provided to a steering shaft via a reaction force transmission mechanism and configured to apply an operation reaction force to the steering operation member by an operation of the reaction force actuator, the steering operation member being coupled to the steering shaft; and
a reaction force controller configured to control the operation reaction force by controlling the reaction force actuator,
wherein the operation amount estimator is included in the reaction force controller,
wherein the reaction force actuator includes a first reaction force motor and a second reaction force motor each as an electric motor,
wherein the reaction force controller includes a first reaction force controller provided corresponding to the first reaction force motor and a second reaction force controller provided corresponding to the second reaction force motor, the second reaction force controller being different from the first reaction force controller,
wherein one steering actuator which is the at least one steering actuator is configured to steer the pair of wheels,
wherein the steering actuator includes a first steering motor and a second steering motor each as an electric motor, and
wherein the steering controller includes a first steering controller configured to control the first steering motor and a second steering controller configured to control the second steering motor, the second steering controller being different from the first steering controller.

(10) The steering system according to item (9), wherein the first steering controller is configured to:
control the first steering motor based on the estimated operation amount estimated by the first reaction force controller when a first reaction force control system including the first reaction force controller is normal, and
control the first steering motor based on the sensor operation amount when the first reaction force control system is abnormal.

(11) The steering system according to item (9), wherein the first steering controller is configured to:
control the first steering motor based on a first estimated operation amount as the estimated operation amount estimated by the first reaction force controller when a first reaction force control system including the first reaction force controller is normal, and
stop the first steering motor when a second reaction force control system including the second reaction force controller is normal and the first reaction force control system is abnormal.

(12) The steering system according to item (9), wherein the first steering controller is configured to:
control the first steering motor based on a second estimated operation amount as the estimated operation amount estimated by the second reaction force controller when a first reaction force control system including the first reaction force controller is abnormal and a second reaction force control system including the second reaction force controller is normal.

(13) The steering system according to any one of item (9) to item (12), wherein the first steering controller is configured to control the first steering motor based on a detection value of the operation amount sensor when both of a first reaction force control system including the first reaction force controller and a second reaction force control system including the second reaction force controller are abnormal.

(14) The steering system according to any one of item (9) to item (13), further comprising an abnormality detector configured to detect the presence or absence of the abnormality of each of the first reaction force control system including the first reaction force controller and the second reaction force control system including the second reaction force controller.

In the above embodiment, it can be considered that the abnormality detector is composed of at least one of the steering main MCU 62a and the steering sub MCU 62b.

What is claimed is:

1. A steering system provided in a vehicle and configured to steer a pair of wheel mechanically disconnected from a steering operation member operable by a driver, the steering system comprising:
an operation amount sensor configured to detect an operation amount of the steering operation member by the driver;
an operation amount estimator configured to estimate an operation amount of the steering operation member which is not based on a detected value of the operation amount sensor;
a steering mechanism including at least one steering actuator and configured to steer the pair of wheels by an operation of the steering actuator; and
a steering controller configured to control a steering angle of the pair of wheels by controlling the at least one steering actuator based on the operation amount of the steering operation member,
wherein the steering controller is configured to:
control the at least one steering actuator based on an estimated operation amount when an operation amount estimation system including the operation amount estimator is normal and
control the at least one steering actuator based on a sensor operation amount when the operation amount estimation system is abnormal,
the estimated operation amount being an operation amount of the steering operation member estimated by the operation amount estimator, the sensor operation amount being an operation amount of the steering operation member detected by the operation amount sensor.

2. The steering system according to claim 1,
wherein the steering controller is configured to control the steering actuator based on the sensor operation amount when the operation amount estimation system is abnormal and the sensor operation amount detected by the operation amount sensor is an appropriate amount for controlling the steering actuator.

3. The steering system according to claim 1, further comprising:
a reaction force applying mechanism including a reaction force actuator coupled to a steering shaft via a reaction force transmission mechanism and configured to apply an operation reaction force to the steering operation member by an operation of the reaction force actuator, the steering operation member being coupled to the steering shaft; and
a reaction force controller configured to control the operation reaction force applied to the steering operation member by controlling the reaction force actuator,
wherein the operation amount estimator is configured to estimate the operation amount of the steering operation member based on a rotation angle of the reaction force actuator.

4. The steering system according to claim 1,
wherein, when an abnormality of the operation amount estimation system is detected, the steering controller is configured to gradually change a control of the at least one steering actuator in a case where the control is switched from the control of the at least one steering actuator based on the estimated operation amount to the control of the at least one steering actuator based on the sensor operation amount.

5. The steering system according to claim 4,
wherein, when the abnormality of the operation amount estimation system is detected, the steering controller is configured to stop the at least one steering actuator and then is configured to gradually increase a supplied current to the at least one steering actuator such that the steering angle of the pair of wheels approaches a target steering angle determined based on the sensor operation amount.

6. The steering system according to claim 4,
wherein, when an absolute value of a difference between an actual steering angle of the pair of wheels and a target steering angle determined based on the sensor operation amount is smaller than a threshold value and/or when an absolute value of the actual steering angle of the pair of wheels is greater than an absolute value of the target steering angle determined based on the sensor operation amount, the steering controller is configured to gradually change a supplied current to the at least one steering actuator such that the steering angle of the pair of wheels approaches the target steering angle, in a case where the abnormality of the operation amount estimation system is detected.

7. The steering system according to claim 1, further comprising:
a reaction force applying mechanism including a reaction force actuator provided to a steering shaft via a reaction force transmission mechanism and configured to apply an operation reaction force to the steering operation member by the operation of the reaction force actuator, the steering operation member being coupled to the steering shaft; and
a reaction force controller configured to control the operation reaction force by controlling the reaction force actuator,
wherein the operation amount estimator is included in the reaction force controller,
wherein the reaction force actuator includes a first reaction force motor and a second reaction force motor each as an electric motor,
wherein the reaction force controller includes a first reaction force controller provided by corresponding to the first reaction force motor and a second reaction force controller provided corresponding to the second reaction force motor, the second reaction force controller being different from the first reaction force controller,
wherein one steering actuator which is the at least one steering actuator is configured to steer the pair of wheels,
wherein the steering actuator includes a first steering motor and a second steering motor each as an electric motor,
wherein the steering controller includes a first steering controller configured to control the first steering motor and a second steering controller configured to control the second steering motor, the second steering controller being different from the first steering controller, and
wherein the first steering controller is configured to:
control the first steering motor based on the estimated operation amount estimated by the first reaction force controller when a first reaction force control system including the first reaction force controller is normal, and
control the first steering motor based on the sensor operation amount when the first reaction force control system is abnormal.

8. The steering system according to claim 1, further comprising:
a reaction force applying mechanism including a reaction force actuator provided to a steering shaft via a reaction force transmission mechanism and configured to apply an operation reaction force to the steering operation member by an operation of the reaction force actuator, the steering operation member being coupled to the steering shaft; and
a reaction force controller configured to control the operation reaction force by controlling the reaction force actuator,
wherein the operation amount estimator is included in the reaction force controller,
wherein the reaction force actuator includes a first reaction force motor and a second reaction force motor each as an electric motor,
wherein the reaction force controller includes a first reaction force controller provided by corresponding to the first reaction force motor and a second reaction force controller provided corresponding to the second reaction force motor, the second reaction force controller being different from the first reaction force controller,
wherein one steering actuator which is the at least one steering actuator is configured to steer the pair of wheels,
wherein the steering actuator includes a first steering motor and a second steering motor each as an electric motor,
wherein the steering controller includes a first steering controller configured to control the first steering motor and a second steering controller configured to control the second steering motor, the second steering controller being different from the first steering controller, and
wherein the first steering controller is configured to control the first steering motor based on a detection value of the operation amount sensor when both of a first reaction force control system including the first reaction force controller and a second reaction force control system including the second reaction force controller are abnormal.
